(19) United States
(12) Patent Application Publication
(10) Pub. No.: US 2023/0097119 A1
(43) Pub. Date: Mar. 30, 2023

(54) Power Storage Device and Method for Manufacturing Power Storage Device

(71) Applicant: TOYOTA JIDOSHA KABUSHIKI KAISHA, Toyota-shi Aichi-ken (JP)

(72) Inventors: Shinichiro Mori, Okazaki-shi Aichi-ken (JP); Ryota Aoki, Okazaki-shi Aichi-ken (JP); Hiroyasu Kado, Toyota-shi Aichi-ken (JP); Hiroya Takeuchi, Toyota-shi Aichiken (JP); Yuuki Yamazaki, Toyota-shi Aichi-ken (JP)

(73) Assignee: TOYOTA JIDOSHA KABUSHIKI KAISHA, Toyota-shi Aichi-ken (JP)

(21) Appl. No.: 17/949,387

(22) Filed: Sep. 21, 2022

(30) Foreign Application Priority Data
Sep. 24, 2021 (JP) 2021-155486

(51) Int. Cl. H01M 10/613; H01M 50/209; H01M 10/6554; H01M 10/653

(52) U.S. Cl. CPC H01M 10/613; H01M 50/209; H01M 10/6554; H01M 10/653; H01M 2220/20

(57) ABSTRACT

A power storage device includes a lower case including a bottom portion, a power storage stack thermally contacting the bottom portion, a cooler disposed below the bottom portion, and a heat conduction member provided between the bottom portion and the cooler, wherein the cooler includes a cooling portion and a pair of holding portions, the heat conduction member includes a pair of first linear portions extending along the pair of holding portions, and a plurality of second linear portions extending along the cooling portion, the cooling portion has a cooling surface contacting the plurality of second linear portions, and, in a cross section of the cooling portion perpendicular to a direction in which the cooling portion extends, a total sum of widths of air layers each formed between the plurality of second linear portions is less than or equal to 14% of a width of the cooling surface.

### CROSS REFERENCE TO RELATED APPLICATIONS

This nonprovisional application claims priority to Japanese Patent Application No. 2021-155486 filed on Sep. 24, 2021 with the Japan Patent Office, the entire contents of which are hereby incorporated by reference.

### BACKGROUND

### Field

The present disclosure relates to a power storage device mounted on a vehicle, and a method for manufacturing the power storage device.

### Description of the Background Art

As a conventional power storage device, Japanese Patent Laying-Open No. 2020-053148 discloses a power storage device which includes a power storage stack and a cooler having a plurality of main cooling surfaces and recesses each provided between the plurality of main cooling surfaces, and in which a gel heat conduction member is disposed between the power storage stack and the plurality of main cooling surfaces, in a configuration in which the power storage stack and the cooler are disposed within a housing case.

### SUMMARY

Unlike the power storage device in Japanese Patent Laying-Open No. 2020-053148, there may be a case where a cooler is disposed outside a housing case. In such a case, it is conceivable to bring a cooler into close contact with a bottom portion of the housing case via a heat conduction member. When the heat conduction member contains air and most of the air cannot be discharged to the outside, adhesiveness of the cooler with respect to a lower case is reduced. Further, when most of the air remains in the heat conduction member, the area of the heat conduction member is also small, and cooling efficiency is reduced.

The present disclosure has been made in view of the aforementioned problem, and an object of the present disclosure is to provide a power storage device that can improve adhesiveness of a cooler with respect to a lower case, and can maintain good cooling efficiency, in a configuration in which the cooler is disposed outside the lower case.

A power storage device based on the present disclosure includes a lower case including a bottom portion having an inner surface and an outer surface opposite to each other, one or more power storage stacks thermally contacting the inner surface of the bottom portion, a cooler disposed below the bottom portion for cooling the one or more power storage stacks, and a heat conduction member provided between the outer surface of the bottom portion and the cooler. The cooler includes one or more cooling portions provided to correspond to the one or more power storage stacks, and a pair of holding portions holding the one or more cooling portions. Each of the one or more cooling portions is provided to bridge the pair of holding portions. The heat conduction member includes a pair of first linear portions disposed between the pair of holding portions and the bottom portion and extending along the pair of holding portions, and a plurality of second linear portions disposed between each of the one or more cooling portions and the bottom portion and extending along the cooling portion. The plurality of second linear portions are provided side by side in a cross direction crossing a direction in which the cooling portion extends. Each of the one or more cooling portions has a cooling surface contacting the plurality of second linear portions. In a cross section of each of the one or more cooling portions perpendicular to the direction in which the cooling portion extends, a total sum of widths of air layers each formed between the plurality of second linear portions is less than or equal to 14% of a width of the cooling surface.

According to the configuration described above, it is possible to let air escape from gaps between the pair of first linear portions and the plurality of second linear portions to the outside, before the pair of first linear portions are connected to the plurality of second linear portions, when the heat conduction member is sandwiched between the bottom portion of the lower case and the cooler, and thereby adhesiveness of the cooler with respect to the lower case can be improved. Further, by setting the total sum of the widths of the air layers to less than or equal to 14% of the width of the cooling surface, the plurality of second linear portions constituting the heat conduction member can have sufficient areas, and thereby good cooling efficiency can be maintained.

In the power storage device based on the present disclosure, the plurality of second linear portions may include three second linear portions arranged in the cross direction. In this case, a width parallel to the cross direction, of a second linear portion located at center in the cross direction, of the three second linear portions, may be larger than a width parallel to the cross direction, of second linear portions located on both sides in the cross direction, of the three second linear portions.

According to the configuration described above, by setting the width of the second linear portion located at the center in the cross direction to be larger than the width of the second linear portions located on the both sides in the cross direction, the ratio of the air layers each formed between the plurality of second linear portions can be reduced.

In the power storage device based on the present disclosure, each of the plurality of second linear portions includes both end portions, and a central portion located between the both end portions, in the direction in which the cooling portion extends. In this case, a width of the both end portions parallel to the cross direction may be larger than a width of the central portion parallel to the cross direction.

According to the configuration described above, since the width of the both end portions of each of the plurality of second linear portions connected to the pair of first linear portions is larger than the width of the central portion of each of the plurality of second linear portions, water from the outside can be suppressed from entering from the both end portions of the plurality of second linear portions into between each cooling portion and the bottom portion.

In the power storage device based on the present disclosure, the heat conduction member may have moisture permeability.

According to the configuration described above, moisture contained in the air layers can be discharged to the outside via the heat conduction member, and thereby the cooler can be prevented from rusting.

A method for manufacturing a power storage device based on the present disclosure includes preparing a lower case including a bottom portion having an inner surface and an outer surface opposite to each other, preparing a cooler, and forming a heat conduction member between the outer surface of the bottom portion and the cooler. In preparing the cooler, the cooler including one or more cooling portions each having a cooling surface, and a pair of holding portions holding the one or more cooling portions such that each of the one or more cooling portions bridges the pair of holding portions, is prepared. Forming the heat conduction member includes forming a pair of first linear portions extending between the pair of holding portions and the bottom portion, along the pair of holding portions, and a plurality of second linear portions extending between each of the one or more cooling portions and the bottom portion, along the cooling portion. In forming the pair of first linear portions and the plurality of second linear portions, the plurality of second linear portions are formed to contact the cooling surface and to be arranged in a cross direction crossing a direction in which the cooling portion extends, and the plurality of second linear portions are formed such that, in a cross section of each of the one or more cooling portions perpendicular to the direction in which the cooling portion extends, a total sum of widths of air layers each formed between the plurality of second linear portions is less than or equal to 14% of a width of the cooling surface.

According to the configuration described above, it is possible to let air escape from gaps between the pair of first linear portions and the plurality of second linear portions to the outside, before the pair of first linear portions are connected to the plurality of second linear portions, when the pair of first linear portions and the plurality of second linear portions are formed in forming the heat conduction member, and thereby adhesiveness of the cooler with respect to the lower case can be improved. Further, by setting the total sum of the widths of the air layers to less than or equal to 14% of the width of the cooling surface, the plurality of second linear portions constituting the heat conduction member can have sufficient areas, and thereby good cooling efficiency can be maintained.

In the method for manufacturing the power storage device based on the present disclosure, forming the pair of first linear portions and the plurality of second linear portions may include applying the heat conduction member such that a pair of first lines that are to serve as the pair of first linear portions are formed on the outer surface of the bottom portion at portions corresponding to the pair of holding portions, and a plurality of second lines that are to serve as the plurality of second linear portions are formed on the outer surface of the bottom portion at a portion corresponding to each of the one or more cooling portions. In some embodiments, in applying the heat conduction member, the plurality of second lines are formed to form gaps between the plurality of second lines and the pair of first lines, and to extend along the cooling portion with a spacing in the cross direction.

According to the configuration described above, the pair of first linear portions and the plurality of second linear portions are formed by connecting the pair of first lines and the plurality of second lines. By forming the plurality of second lines to form the gaps between the plurality of second lines and the pair of first lines, and to extend along the cooling portion with a spacing in the cross direction, it is possible to let the air escape from the gaps between the pair of first lines and the plurality of second lines to the outside, when the pair of first lines and the plurality of second lines are connected to form the pair of first linear portions and the plurality of second linear portions. Thus, adhesiveness of the cooler with respect to the lower case can be improved.

In some embodiments, the method for manufacturing the power storage device based on the present disclosure, forming the pair of first linear portions and the plurality of second linear portions includes sandwiching the pair of first lines and the plurality of second lines between the cooler and the bottom portion, and pressing and enlarging the plurality of second lines sandwiched between the cooler and the bottom portion, using a roller device.

According to the configuration described above, by pressing and enlarging the plurality of second lines with the roller device, it is possible to let air located between the plurality of second lines escape from the gaps between the plurality of second lines and the pair of first lines to the outside. Further, by pressing and enlarging the plurality of second lines, the plurality of second linear portions are formed with large areas.

In the method for manufacturing the power storage device based on the present disclosure, in pressing and enlarging the plurality of second lines using the roller device, rollers of the roller device may be moved, while being rotated, from one end side toward another end side of the plurality of second lines, to press the cooler against the bottom portion from a side opposite to a side on which the heat conduction member is located.

According to the configuration described above, the plurality of second lines can be easily pressed to be enlarged using the rollers.

In the method for manufacturing the power storage device based on the present disclosure, as the heat conduction member, a member having moisture permeability may be used.

According to the configuration described above, moisture contained in the air layers can be discharged to the outside via the heat conduction member, and thereby the cooler can be prevented from rusting.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an exploded perspective view of a power storage device in accordance with an embodiment.

FIG. 2 is a plan view of a cooler in accordance with the embodiment.

FIG. 3 is a plan view showing positional relation between a heat conduction member and the cooler in accordance with the embodiment.

FIG. 4 is a cross sectional view showing a state where the heat conduction member is sandwiched between a cooling portion of the cooler and a bottom portion of a lower case, in the power storage device in accordance with the embodiment.

FIG. 5 is a flowchart showing a process of manufacturing the power storage device in accordance with the embodiment.

FIG. 6 is a view showing a step of applying a heat conduction member, in the process of manufacturing the power storage device in accordance with the embodiment.

FIG. 7 is a plan view showing a later state of the step of applying the heat conduction member shown in FIG. 6.

FIG. 8 is a view showing a step of sandwiching a pair of first lines and a plurality of second lines between the cooler and the bottom portion of the lower case, in the process of manufacturing the power storage device in accordance with the embodiment.

FIG. 9 is a view showing a step of pressing and enlarging the plurality of second lines with rollers, in the process of manufacturing the power storage device in accordance with the embodiment.

FIG. 10 is a plan view showing the step of pressing and enlarging the plurality of second lines with the rollers shown in FIG. 9.

FIG. 11 is a view showing a step of attaching a share panel, in the process of manufacturing the power storage device in accordance with the embodiment.

FIG. 12 is a view showing a first step of a step of attaching a power storage stack, in the process of manufacturing the power storage device in accordance with the embodiment.

FIG. 13 is a view showing a second step of the step of attaching the power storage stack, in the process of manufacturing the power storage device in accordance with the embodiment.

### DESCRIPTION OF THE EMBODIMENTS

Hereinafter, an embodiment of the present disclosure will be described in detail with reference to the drawings. It should be noted that, in the embodiment described below, identical or common parts will be designated by the same reference numerals in the drawings, and the description thereof will not be repeated.

(Power Storage Device)

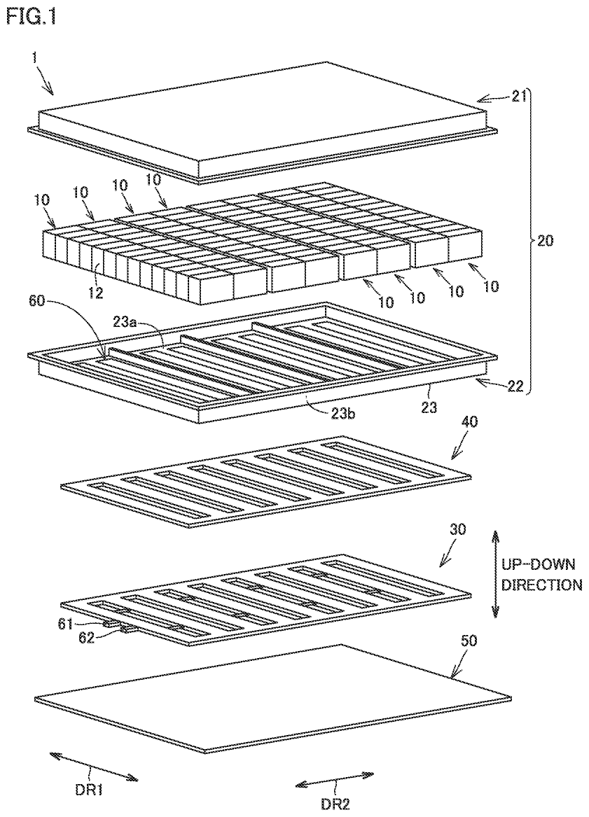

FIG. 1 is an exploded perspective view of a power storage device in accordance with an embodiment. Referring to FIG. 1, a power storage device 1 in accordance with the embodiment will be described.

Power storage device 1 in accordance with the embodiment is mounted on a hybrid vehicle that can run using motive power of at least one of a motor and an engine, or an electrically powered vehicle that runs using a driving force obtained by electrical energy.

As shown in FIG. 1, power storage device 1 in accordance with the embodiment includes a plurality of power storage stacks 10, a housing case 20, a cooler 30, a heat conduction member 40, a share panel 50, and an inner heat conduction layer 60.

The plurality of power storage stacks 10 each include a plurality of power storage cells 12 arranged in a predetermined arrangement direction (a DR1 direction). It should be noted that, in a mounted state where power storage device 1 is mounted on the vehicle, DR1 direction is parallel to a width direction of the vehicle, for example.

Each power storage cell 12 is, for example, a secondary battery such as a nickel-hydrogen battery or a lithium ion battery. Power storage cell 12 has a rectangular shape, for example. Power storage cell 12 may be a power storage cell using a liquid electrolyte, or a power storage cell using a solid electrolyte. Further, power storage cell 12 may be a unit capacitor configured to store power.

The plurality of power storage stacks 10 are disposed side by side with a spacing in a direction perpendicular to the arrangement direction (i.e., in a DR2 direction). In the mounted state, DR2 direction is parallel to a front-rear direction of the vehicle, for example.

Housing case 20 houses the plurality of power storage stacks 10. Housing case 20 includes an upper case 21 and a lower case 22.

Upper case 21 has a substantially box shape opened downward. Upper case 21 may be made of a metal material. Further, upper case 21 may be made of a resin material for weight reduction.

Lower case 22 has a substantially box shape opened upward. Lower case 22 is made of a metal material. In some embodiments, lower case 22 has good heat conductivity.

Lower case 22 has a bottom portion 23. The plurality of power storage stacks 10 are mounted on bottom portion 23. Bottom portion 23 has an inner surface 23a and an outer surface 23b opposite to each other. Inner surface 23a faces toward the plurality of power storage stacks 10. Outer surface 23b faces opposite to a side on which the plurality of power storage stacks 10 are located.

Inner heat conduction layer 60 is disposed between each power storage stack 10 and inner surface 23a. Inner heat conduction layer 60 also functions as an adhesion layer, and adheres and fixes each power storage stack 10 to bottom portion 23. Each power storage stack 10 is brought into thermal contact with inner surface 23a by inner heat conduction layer 60.

Inner heat conduction layer 60 is made of a resin member having heat conductivity. As inner heat conduction layer 60, for example, an adhesive containing a silicone-based resin, an acrylic-based resin, an urethane resin, an epoxy resin, or the like can be adopted.

Cooler 30 is a device for cooling the plurality of power storage stacks 10. A refrigerant flow path through which a refrigerant flows is provided inside cooler 30. The refrigerant flow path is connected to a refrigerant introducing portion 61 and a refrigerant discharging portion 62. The refrigerant introduced from refrigerant introducing portion 61 into the refrigerant flow path cools the plurality of power storage stacks 10, and is discharged from refrigerant discharging portion 62.

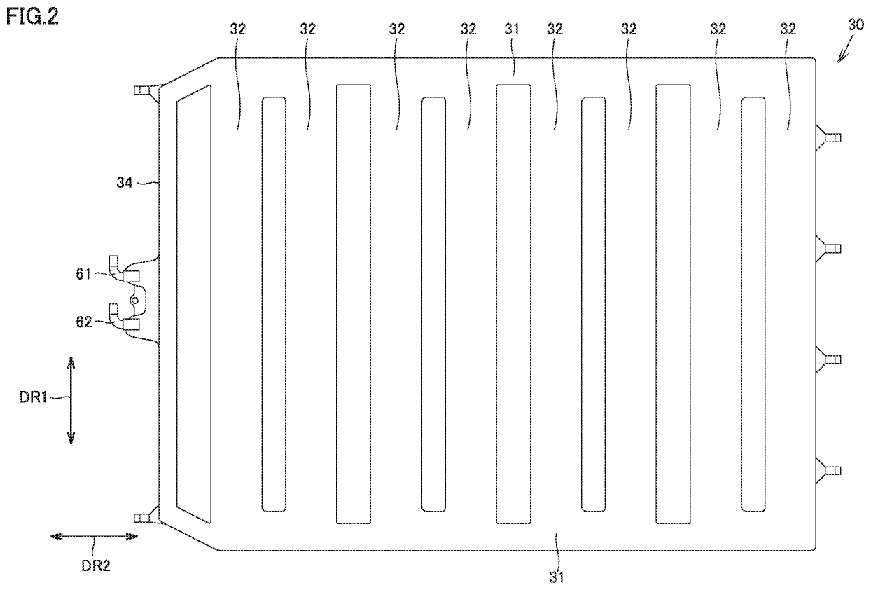

Cooler 30 is disposed below bottom portion 23 of lower case 22. Cooler 30 is made of a metal material such as aluminum. A detailed structure of cooler 30 will be described later using FIG. 2.

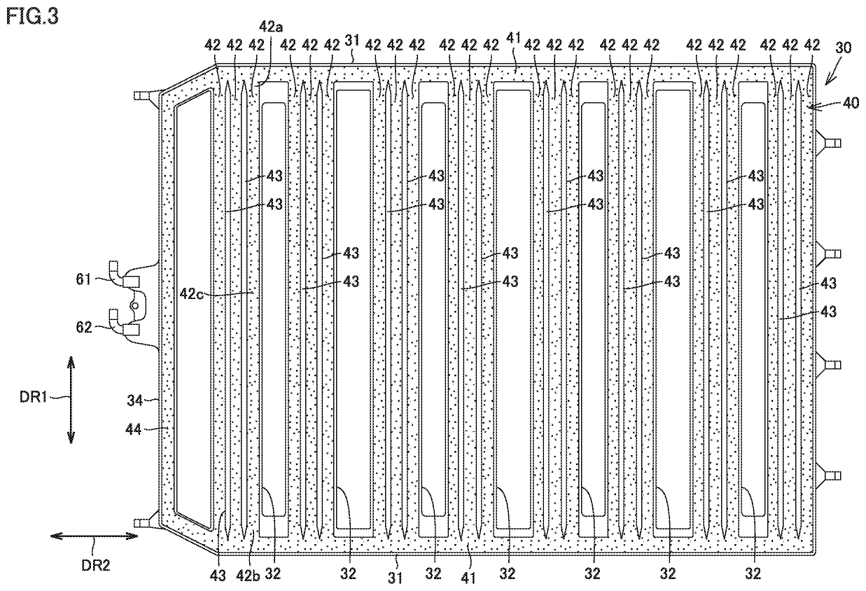

Heat conduction member 40 is disposed between outer surface 23b of bottom portion 23 and cooler 30. Via heat conduction member 40, bottom portion 23, and inner heat conduction layer 60, the plurality of power storage stacks 10 are cooled by cooler 30. Heat conduction member 40 also functions as an adhesion layer that adheres bottom portion 23 and cooler 30. As heat conduction member 40, for example, an adhesive containing a silicone-based resin, an acrylic-based resin, an urethane resin, an epoxy resin, or the like can be adopted. A detailed structure of heat conduction member 40 will be described later using FIG. 3.

Share panel 50 is disposed to cover cooler 30 from a lower side. Share panel 50 protects cooler 30 and suppresses cooler 30 from being wetted by water. Share panel 50 is made of a metal material. Share panel 50 includes a cover panel.

FIG. 2 is a plan view of the cooler in accordance with the embodiment. Referring to FIG. 2, a detailed structure of cooler 30 will be described.

Cooler 30 includes a pair of holding portions 31, a plurality of cooling portions 32, and a projecting portion 34. The refrigerant flow path is routed inside the pair of holding portions 31, the plurality of cooling portions 32, and projecting portion 34.

The pair of holding portions 31 extend along DR2 direction. The pair of holding portions 31 are disposed to be spaced from each other in DR1 direction. The pair of holding portions 31 hold the plurality of cooling portions 32.

The plurality of cooling portions 32 are disposed at positions respectively corresponding to the plurality of power storage stacks 10. The plurality of cooling portions 32 are provided corresponding to the number of the plurality of power storage stacks 10. Each of the plurality of cooling portions 32 is provided to bridge the pair of holding portions 31. The plurality of cooling portions 32 are disposed side by side with a spacing in DR2 direction.

Projecting portion 34 is provided to project from one end side of the pair of holding portions 31 toward one side in DR2 direction. Projecting portion 34 has a substantially C shape. Projecting portion 34 is provided with refrigerant introducing portion 61 and refrigerant discharging portion 62 described above.

FIG. 3 is a plan view showing positional relation between the heat conduction member and the cooler in accordance with the embodiment. Referring to FIG. 3, details of heat conduction member 40 will be described.

Heat conduction member 40 includes a pair of first linear portions 41 disposed between the pair of holding portions 31 and bottom portion 23, a plurality of second linear portions 42 disposed between each of the plurality of cooling portions 32 and bottom portion 23, and a third linear portion 44.

The pair of first linear portions 41 are provided to extend along the pair of holding portions 31. Specifically, the pair of first linear portions 41 are provided to extend along DR2 direction.

The plurality of second linear portions 42 are provided to extend along each cooling portion 32. Specifically, the plurality of second linear portions 42 are provided to extend along DR1 direction. The plurality of second linear portions 42 are disposed side by side in a cross direction crossing a direction in which each cooling portion 32 extends. In the present embodiment, between each cooling portion 32 and bottom portion 23, the plurality of second linear portions 42 include three second linear portions 42 arranged in the cross direction. The cross direction is parallel to DR2 direction, for example. Air layers 43 are each formed between second linear portions 42 adjacent to each other in the cross direction.

It should be noted that, although FIG. 3 illustrates the case where each air layer 43 is formed continuously from one end side to the other end side of the plurality of second linear portions 42 in DR1 direction, each air layer 43 may be formed intermittently in DR1 direction, or may be formed partially in DR1 direction.

In the direction in which each cooling portion 32 extends (DR1 direction), each of the plurality of second linear portions 42 includes both end portions 42a and 42b, and a central portion 42c located between both end portions 42a and 42b. Both end portions 42a and 42b are connected to the pair of first linear portions 41. A width of both end portions 42a and 42b parallel to the cross direction is larger than a width of central portion 42c parallel to the cross direction. This can suppress water from the outside from entering from both end portions 42a and 42b of the plurality of second linear portions 42 into between each cooling portion 32 and bottom portion 23.

Third linear portion 44 is disposed between projecting portion 34 and bottom portion 23. Third linear portion 44 is provided to project from one end side of the pair of first linear portions 41 toward the one side in DR2 direction. Third linear portion 44 has a substantially C shape.

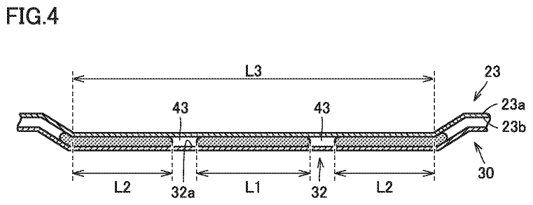

FIG. 4 is a cross sectional view showing a state where the heat conduction member is sandwiched between a cooling portion of the cooler and the bottom portion of the lower case, in the power storage device in accordance with the embodiment.

As shown in FIG. 4, cooling portion 32 has a cooling surface 32a facing bottom portion 23 at a portion where power storage stack 10 is disposed. The plurality of second linear portions 42 contact at least both end portions and a central portion of cooling surface 32a in DR2 direction.

On cooling surface 32a, a width L1 parallel to the cross direction, of second linear portion 42 located at the center in the cross direction, of the three second linear portions 42, is larger than a width L2 parallel to the cross direction, of second linear portions 42 located on both sides in the cross direction, of the three second linear portions 42. Cooling surface 32a has a width L3 in DR2 direction.

Here, in a cross section of cooling portion 32 perpendicular to the direction in which cooling portion 32 extends, a total sum (L3−L1−2×L2) of widths of air layers 43 each formed between the plurality of second linear portions 42 is less than or equal to approximately 14% of the width (L3) of cooling surface 32a.

By setting the total sum of the widths of air layers 43 to less than or equal to 14% of the width of cooling surface 32a in this manner, the plurality of second linear portions 42 constituting heat conduction member 40 can have sufficient areas, and thereby good cooling efficiency can be maintained.

Further, by setting width L1 of second linear portion 42 located at the center in the cross direction to be larger than width L2 of second linear portions 42 located on the both sides in the cross direction, the ratio of air layers 43 each formed between the plurality of second linear portions 42 can be reduced. Thereby, cooling efficiency can be further improved.

In addition, by forming the plurality of second linear portions 42 side by side in the cross direction between each cooling portion 32 and bottom portion 23, it is possible to let air escape from gaps between the pair of first linear portions 41 and the plurality of second linear portions 42 to the outside, before the pair of first linear portions 41 are connected to the plurality of second linear portions 42, when heat conduction member 40 is sandwiched between bottom portion 23 of lower case 22 and cooler 30, as described later. Thereby, adhesiveness of cooler 30 with respect to lower case 22 can be improved.

It should be noted that, although the above description illustrates the case where width L1 of second linear portion 42 located at the center in the cross direction is larger than width L2 of second linear portions 42 located on the both sides in the cross direction, the present disclosure is not limited thereto, and the three second linear portions 42 may have a substantially equal width. That is, width L1 may be substantially equal to width L2.

(Method for Manufacturing Power Storage Device)

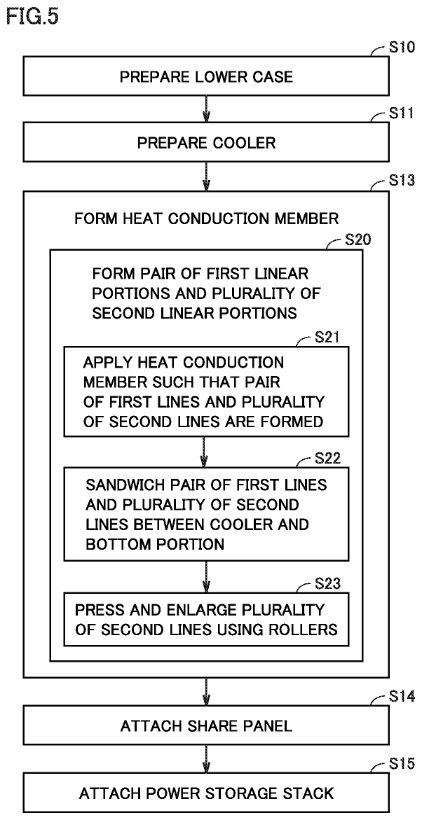

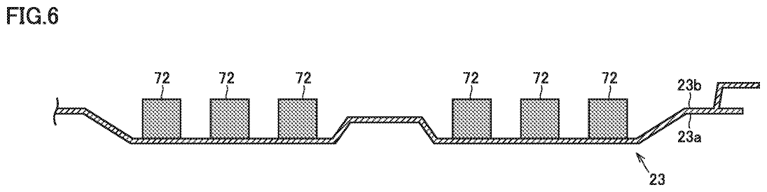

FIG. 5 is a flowchart showing a process of manufacturing the power storage device in accordance with the embodiment. FIGS. 6 to 13 are views each showing a predetermined step, or a later state of the predetermined step, in the process of manufacturing the power storage device. Referring to FIGS. 5 to 13, a method for manufacturing power storage device 1 in accordance with the embodiment will be described.

As shown in FIG. 5, the method for manufacturing power storage device 1 includes a step (S10) of preparing lower case 22, a step (S11) of preparing the cooler, a step (S13) of forming heat conduction member 40, a step (S14) of attaching share panel 50, and a step (S15) of attaching power storage stack 10.

In manufacturing power storage device 1, first, in step (S10), lower case 22 is prepared. Specifically, lower case 22 including bottom portion 23 having inner surface 23a and outer surface 23b opposite to each other is prepared.

Subsequently, in step (S11), cooler 30 is prepared. Specifically, cooler 30 including the plurality of cooling portions 32 each having cooling surface 32a, and the pair of holding portions 31 holding the plurality of cooling portions 32 such that each of the plurality of cooling portions 32 bridges the pair of holding portions 31, is prepared. The plurality of cooling portions 32 are disposed side by side with a spacing in DR2 direction as described above, and projecting portion 34 projecting in the substantially C shape on the one side in DR2 direction is provided from the one end side of the pair of holding portions 31.

It should be noted that step (S11) may be performed before step (S10), or may be performed in parallel with step (S10).

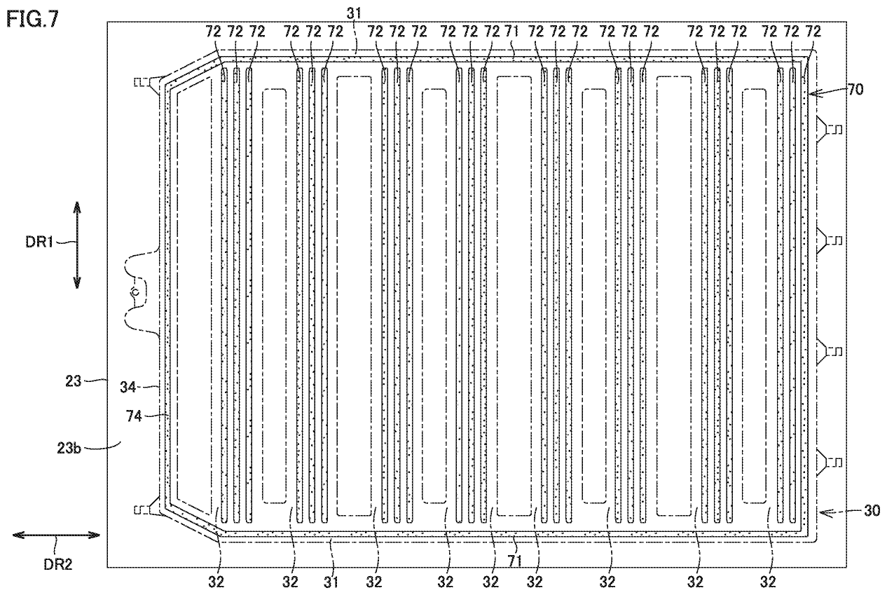

Subsequently, in step (S13), heat conduction member 40 is formed. Step (S13) includes a step (S20) of forming the pair of first linear portions 41 and the plurality of second linear portions 42. Step (S20) has a step (S21) of applying a heat conduction member 70 (more specifically, a precursor of heat conduction member 40) such that a pair of first lines 71 (see FIG. 7) and a plurality of second lines 72 (see FIG. 7) are formed, a step (S22) of sandwiching the pair of first lines 71 and the plurality of second lines 72 between cooler 30 and the bottom portion, and a step (S23) of pressing and enlarging the plurality of second lines 72 using a roller device 80.

In step (S20), the pair of first linear portions 41 extending between the pair of holding portions 31 and bottom portion 23, along the pair of holding portions 31, and the plurality of second linear portions 42 extending between each of the plurality of cooling portions 32 and bottom portion 23, along cooling portion 32, are formed.

Specifically, the plurality of second linear portions 42 are formed to contact cooling surface 32a and to be arranged in the cross direction crossing the direction in which cooling portion 32 extends, and the plurality of second linear portions 42 are formed such that, in a cross section of each of the plurality of cooling portions 32 perpendicular to the direction in which cooling portion 32 extends, the total sum of the widths of air layers 43 each formed between the plurality of second linear portions 42 is less than or equal to 14% of the width of cooling surface 32a.

In order to form the pair of first linear portions 41 and the plurality of second linear portions 42, first, in step (S21), heat conduction member 70 is applied, as described above.

FIG. 6 is a view showing the step of applying the heat conduction member, in the process of manufacturing the power storage device in accordance with the embodiment. FIG. 7 is a plan view showing a later state of the step of applying the heat conduction member shown in FIG. 6. It should be noted that, in FIG. 7, cooler 30 is indicated by alternate long and short dash lines for the sake of convenience.

As shown in FIGS. 6 and 7, in step (S21), heat conduction member 70 is applied such that the pair of first lines 71 that are to serve as the pair of first linear portions 41 are formed on outer surface 23b of bottom portion 23 at portions corresponding to the pair of holding portions 31, and the plurality of second lines 72 that are to serve as the plurality of second linear portions 42 are formed on outer surface 23b of bottom portion 23 at a portion corresponding to each of the plurality of cooling portions 32. On this occasion, heat conduction member 70 is applied such that a third line 74 that is to serve as third linear portion 44 is also formed. Third line 74 is formed on outer surface 23b of bottom portion 23 at a portion corresponding to projecting portion 34.

It should be noted that, when heat conduction member 70 is applied on outer surface 23b, lower case 22 is disposed such that outer surface 23b faces upward.

Furthermore, in step (S21), the plurality of second lines 72 are formed to form gaps between the plurality of second lines 72 and the pair of first lines 71, and to extend along cooling portion 32 with a spacing in the cross direction.

On this occasion, the plurality of second lines 72 are formed to include three second lines 72 on outer surface 23b of bottom portion 23 at a portion corresponding to each cooling portion 32. For example, the three second lines 72 are formed such that the width of second line 72 located at the center in the cross direction, of the three second lines 72, is larger than the width of second lines 72 located on both sides in the cross direction, of the three second lines 72. It should be noted that the three second lines 72 may be formed such that they have the same width in the cross direction.

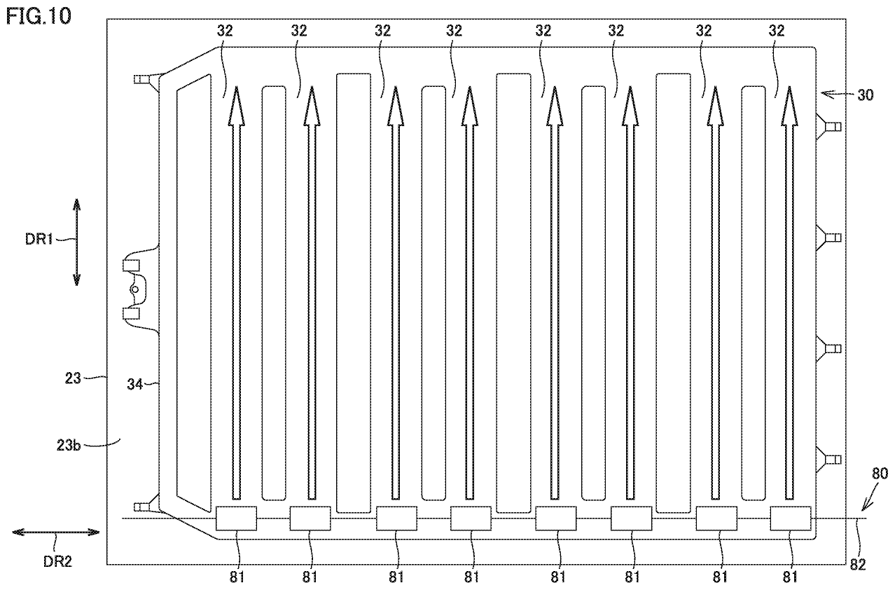

In some embodiments, the gap is smaller than the diameter of a roller 81 (see FIG. 10) described later. Thereby, when the plurality of second lines 72 are pressed to be enlarged by roller 81, the pair of first lines 71 can be reliably connected to one end side of the plurality of second lines on a rotation starting point side of roller 81.

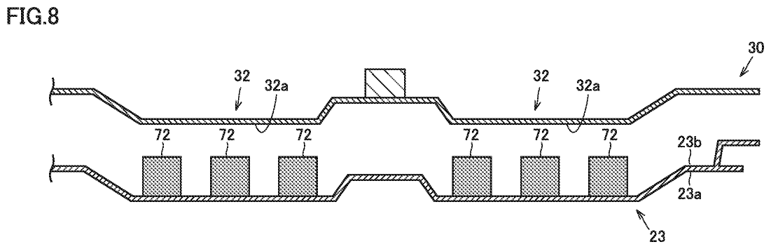

FIG. 8 is a view showing the step of sandwiching the pair of first lines and the plurality of second lines between the cooler and the bottom portion of the lower case, in the process of manufacturing the power storage device in accordance with the embodiment.

Subsequently, as shown in FIGS. 5 and 8, in step (S22), the pair of first lines 71 and the plurality of second lines 72 are sandwiched between cooler 30 and bottom portion 23. Specifically, cooler 30 is disposed above bottom portion 23 such that cooling surface 32a faces outer surface 23b of bottom portion 23. Then, cooler 30 is moved toward bottom portion 23. Thereby, the pair of first lines 71 and the plurality of second lines 72 are sandwiched between cooler 30 and bottom portion 23.

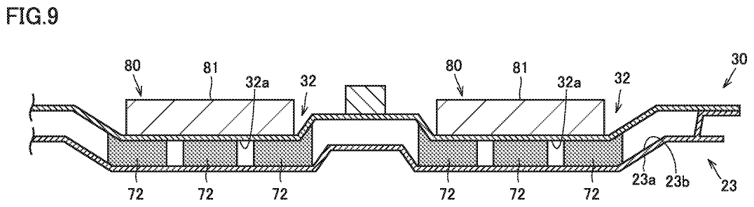

FIG. 9 is a view showing the step of pressing and enlarging the plurality of second lines with rollers, in the process of manufacturing the power storage device in accordance with the embodiment. FIG. 10 is a plan view showing the step of pressing and enlarging the plurality of second lines with the rollers shown in FIG. 9.

Subsequently, as shown in FIGS. 5 and 9 to 11, in step (S23), the plurality of second lines 72 sandwiched between cooler 30 and bottom portion 23 are pressed to be enlarged using roller device 80.

Roller device 80 includes a plurality of rollers 81, and a shaft portion 82 rotatably supporting the plurality of rollers 81. The plurality of rollers 81 are provided at positions corresponding to respective cooling portions 32.

In step (S23), specifically, rollers 81 are moved, while being rotated, from the one end side toward the other end side of the plurality of second lines 72 as indicated by arrows in FIG. 10, to press cooler 30 against bottom portion 23 from a side opposite to a side on which heat conduction member 70 is located.

By pressing and enlarging the plurality of second lines 72 with roller device 80 in this manner, it is possible to let air located between the plurality of second lines 72 escape from the gaps between the plurality of second lines 72 and the pair of first lines 71 to the outside, before the pair of first lines 71 are connected to the plurality of second lines 72. Further, by pressing and enlarging the plurality of second lines 72, the plurality of second linear portions 42 are formed with large areas, and the total sum of the widths of air layers 43 becomes less than or equal to 14% of the width of cooling surface 32a.

The pair of first linear portions 41 and the plurality of second linear portions 42 are formed by connecting the pair of first lines 71 and the plurality of second lines 72. By forming the plurality of second lines 72 to form the gaps between the plurality of second lines 72 and the pair of first lines 71, and to extend along cooling portion 32 with a spacing in the cross direction, it is possible to let the air escape from the gaps between the pair of first lines 71 and the plurality of second lines 72 to the outside, when the pair of first lines 71 and the plurality of second lines 72 are connected to form the pair of first linear portions 41 and the plurality of second linear portions 42. Thus, adhesiveness of cooler 30 with respect to lower case 22 can be improved.

Further, since rigidity of cooler 30 is smaller than rigidity of bottom portion 23, the plurality of second lines 72 can be easily pressed to be enlarged by pressing cooler 30 against bottom portion 23 while rotating rollers 81.

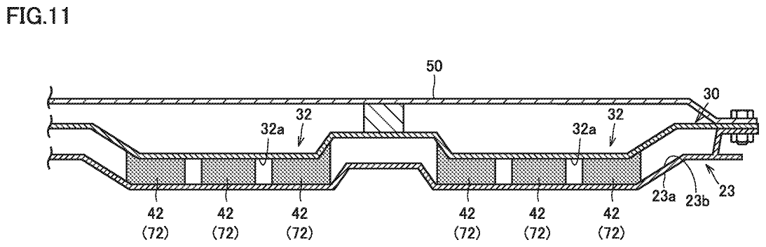

FIG. 11 is a view showing the step of attaching the share panel, in the process of manufacturing the power storage device in accordance with the embodiment.

Subsequently, as shown in FIGS. 5 and 11, in step (S14), share panel 50 is attached to bottom portion 23 to cover cooler 30.

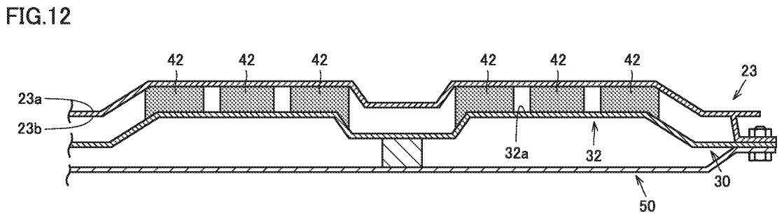

FIG. 12 is a view showing a first step of the step of attaching the power storage stack, in the process of manufacturing the power storage device in accordance with the embodiment.

Subsequently, as shown in FIGS. 5 and 12, in the first step of step (S15), lower case 22 having share panel 50 and cooler 30 attached thereto is reversed such that inner surface 23a of bottom portion 23 faces upward.

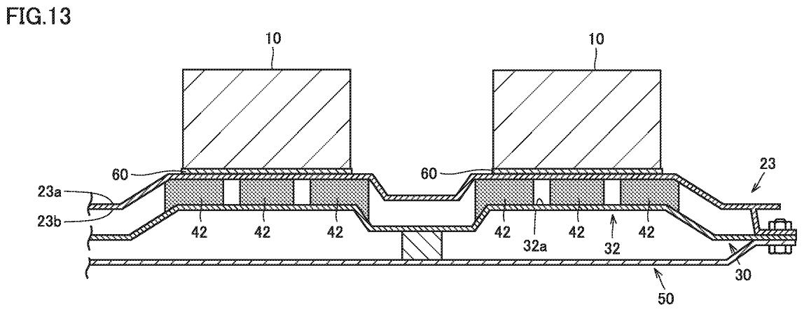

FIG. 13 is a view showing a second step of the step of attaching the power storage stack, in the process of manufacturing the power storage device in accordance with the embodiment.

Subsequently, as shown in FIGS. 5 and 13, inner heat conduction layer 60 is provided on inner surface 23a at a portion corresponding to each cooling portion 32, and power storage stack 10 is attached to lower case 22 such that inner heat conduction layer 60 is sandwiched between bottom portion 23 and power storage stack 10.

Through the steps as described above, power storage stack 10 in accordance with the embodiment can be manufactured.

(Other Variations)

Although the embodiment described above illustrates the case where heat conduction member 70 is applied on outer surface 23b of bottom portion 23 in the step (S21) of applying heat conduction member 70, the present disclosure is not limited thereto, and heat conduction member 70 may be applied to cooler 30. In this case, heat conduction member 70 is applied such that the pair of first lines 71 that are to serve as the pair of first linear portions 41 are formed on the pair of holding portions 31, and the plurality of second lines 72 that are to serve as the plurality of second linear portions 42 are formed on each of the plurality of cooling portions 32.

Although the embodiment described above illustrates the case where power storage stacks 10 are provided in plural numbers, the number of power storage stacks 10 may be one. In this case, the number of cooling portions 32 may also be one. Thus, it is satisfactory as long as one or more cooling portions 32 are provided.

Although the embodiment of the present disclosure has been described, it should be understood that the embodiment disclosed herein is illustrative and non-restrictive in every respect. The scope of the present disclosure is defined by the scope of the claims, and is intended to include any modifications within the scope and meaning equivalent to the scope of the claims.

What is claimed is:

1. A power storage device comprising:
a lower case including a bottom portion having an inner surface and an outer surface opposite to each other;
one or more power storage stacks thermally contacting the inner surface of the bottom portion;
a cooler disposed below the bottom portion for cooling the one or more power storage stacks; and
a heat conduction member provided between the outer surface of the bottom portion and the cooler, wherein
the cooler includes one or more cooling portions provided to correspond to the one or more power storage stacks, and a pair of holding portions holding the one or more cooling portions,
each of the one or more cooling portions is provided to bridge the pair of holding portions,
the heat conduction member includes a pair of first linear portions disposed between the pair of holding portions and the bottom portion and extending along the pair of holding portions, and a plurality of second linear portions disposed between each of the one or more cooling portions and the bottom portion and extending along the cooling portion,
the plurality of second linear portions are provided side by side in a cross direction crossing a direction in which the cooling portion extends,
each of the one or more cooling portions has a cooling surface contacting the plurality of second linear portions, and
in a cross section of each of the one or more cooling portions perpendicular to the direction in which the cooling portion extends, a total sum of widths of air layers each formed between the plurality of second linear portions is less than or equal to 14% of a width of the cooling surface.

2. The power storage device according to claim 1, wherein
the plurality of second linear portions include three second linear portions arranged in the cross direction, and
a width parallel to the cross direction, of a second linear portion located at center in the cross direction, of the three second linear portions, is larger than a width parallel to the cross direction, of second linear portions located on both sides in the cross direction, of the three second linear portions.

3. The power storage device according to claim 1, wherein
each of the plurality of second linear portions includes both end portions, and a central portion located between the both end portions, in the direction in which the cooling portion extends, and
a width of the both end portions parallel to the cross direction is larger than a width of the central portion parallel to the cross direction.

4. The power storage device according to claim 1, wherein the heat conduction member has moisture permeability.

5. A method for manufacturing a power storage device, the method comprising:
preparing a lower case including a bottom portion having an inner surface and an outer surface opposite to each other;
preparing a cooler; and
forming a heat conduction member between the outer surface of the bottom portion and the cooler, wherein
in preparing the cooler, the cooler including one or more cooling portions each having a cooling surface, and a pair of holding portions holding the one or more cooling portions such that each of the one or more cooling portions bridges the pair of holding portions, is prepared,
forming the heat conduction member includes forming a pair of first linear portions extending between the pair of holding portions and the bottom portion, along the pair of holding portions, and a plurality of second linear portions extending between each of the one or more cooling portions and the bottom portion, along the cooling portion,
in forming the pair of first linear portions and the plurality of second linear portions, the plurality of second linear portions are formed to contact the cooling surface and to be arranged in a cross direction crossing a direction in which the cooling portion extends, and the plurality of second linear portions are formed such that, in a cross section of each of the one or more cooling portions perpendicular to the direction in which the cooling portion extends, a total sum of widths of air layers each formed between the plurality of second linear portions is less than or equal to 14% of a width of the cooling surface.

6. The method for manufacturing the power storage device according to claim 5, wherein
forming the pair of first linear portions and the plurality of second linear portions includes applying the heat conduction member such that a pair of first lines that are to serve as the pair of first linear portions are formed on the outer surface of the bottom portion at portions corresponding to the pair of holding portions, and a plurality of second lines that are to serve as the plurality of second linear portions are formed on the outer surface of the bottom portion at a portion corresponding to each of the one or more cooling portions, and
in applying the heat conduction member, the plurality of second lines are formed to form gaps between the plurality of second lines and the pair of first lines, and to extend along the cooling portion with a spacing in the cross direction.

7. The method for manufacturing the power storage device according to claim 6, wherein forming the pair of first linear portions and the plurality of second linear portions includes sandwiching the pair of first lines and the plurality of second lines between the cooler and the bottom portion, and pressing and enlarging the plurality of second lines sandwiched between the cooler and the bottom portion, using a roller device.

8. The method for manufacturing the power storage device according to claim 7, wherein, in pressing and enlarging the plurality of second lines using the roller device, rollers of the roller device are moved, while being rotated, from one end side toward another end side of the plurality of second lines, to press the cooler against the bottom portion from a side opposite to a side on which the heat conduction member is located.

9. The method for manufacturing the power storage device according to claim 5, wherein, as the heat conduction member, a member having moisture permeability is used.
